(19) United States
(12) Patent Application Publication
(10) Pub. No.: US 2011/0111715 A1
(43) Pub. Date: May 12, 2011

(54) OUTDOOR UNIT INSTALLATION AID FEATURE

(75) Inventors: Kenneth Buer, Gilbert, AZ (US); Ramana Darapu, Gilbert, AZ (US)

(73) Assignee: VIASAT, INC., Carlsbad, CA (US)

(21) Appl. No.: 12/613,706

(22) Filed: Nov. 6, 2009

(51) Int. Cl. H04B 17/00

(52) U.S. Cl. 455/226.2

(57) ABSTRACT

In an exemplary embodiment, an outdoor unit of an antenna system includes an audio device that generates a sound that aids in the aiming of the antenna system. The sound is based on the strength of the received signal. Furthermore, in an exemplary embodiment, the sound indicates the signal strength using tone, pitch, repetition, volume, and the like. This sound can be used by a person to aim an antenna system in order to receive a better signal. The person installing the antenna system can be a professional installer, a layperson, or the consumer because the installer does not require any special skills or equipment.

### FIELD OF THE INVENTION

The present invention generally relates to systems, methods, and devices for aligning an outdoor receiver unit using a built-in audio device.

### BACKGROUND OF THE INVENTION

During installation of an outdoor satellite receiver unit, the outdoor unit needs to be aligned in a position to receive a strong signal. In a typical prior art system and with reference to FIG. 1, an antenna system 100 has an antenna dish 110 and an outdoor unit 120 that may include a transceiver, feed horn, and other antenna components. Various devices can be used to help an installer decide the optimal positioning of antenna system 100. One such device is a separate handheld device that connects to outdoor unit 120 and reads the receive signal strength. This handheld unit can provide an information display indicating if antenna system 100 should be redirected for stronger signals. This handheld device is convenient for a professional installer who can use it during multiple installations. However, the typical handheld device is expensive and is not convenient for a self-installer or limited use installer.

Another common method of aiming antenna system 100 is for the outdoor unit to send satellite signals to a connected television receiver unit or set-top box. The television receiver unit can read the signals and provide feedback as to the signal strength using a visual display or by an audio indicator. This method is less expensive than a handheld device because the outdoor unit is already connected to a television receiver and no separate equipment is needed. The drawback of using the television receiver unit to provide the feedback is that the outdoor unit is often installed in a location that is not conveniently near the television receiver unit. For example, an installer would not be able to see a television while installing the outdoor unit on a roof. Moreover, audio signals may be difficult to hear if the television unit is far away from the installation spot.

Thus, it is desirable to have a system, method and apparatus for aiding the aiming of an antenna system in an inexpensive and convenient manner. In may further be desirable for the method and apparatus to be useable by a typical consumer or layperson for installation and/or of an antenna system to obtain a strong satellite signal.

### SUMMARY OF THE INVENTION

In an exemplary embodiment, an outdoor unit of an antenna system includes an audio device that generates a sound that aids in the aiming of the antenna system. The sound is based on the strength of the received signal. Furthermore, in an exemplary embodiment, the sound indicates the signal strength using tone, pitch, repetition, volume, and the like. This sound can be used by a person to aim an antenna system in order to receive a better signal. The person installing the antenna system can be a professional installer, a layperson, or the consumer because the installer does not require any special skills or equipment.

### BRIEF DESCRIPTION OF THE DRAWINGS

A more complete understanding of the present invention may be derived by referring to the detailed description and claims when considered in connection with the Figures, where like reference numbers refer to similar elements throughout the Figures, and:

FIG. 1 illustrates a perspective view of a prior art antenna system without a speaker;

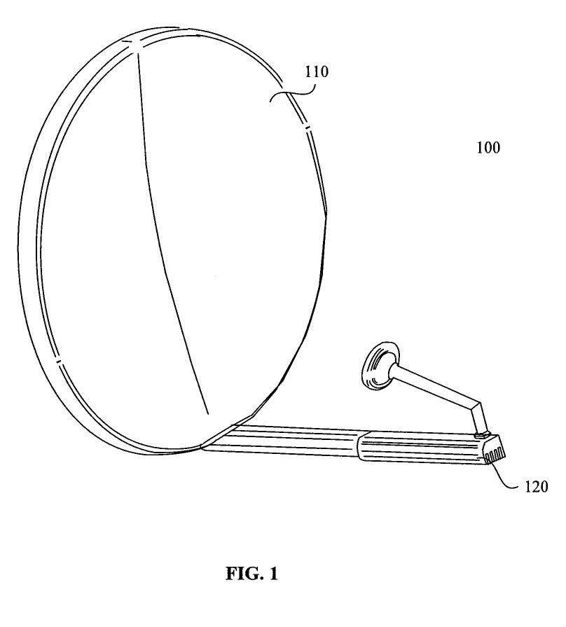

FIG. 2 illustrates a perspective view of an exemplary antenna system with a speaker;

FIG. 3 illustrates a block diagram of an exemplary embodiment of an antenna system with speaker; and

FIG. 4 illustrates a flowchart of an exemplary method of aiming an antenna system to increase signal strength.

### DETAILED DESCRIPTION

While exemplary embodiments are described herein in sufficient detail to enable those skilled in the art to practice the invention, it should be understood that other embodiments may be realized and that logical material, electrical, and mechanical changes may be made without departing from the spirit and scope of the invention. Thus, the following detailed description is presented for purposes of illustration only. Furthermore, references to components or devices may be used interchangeably.

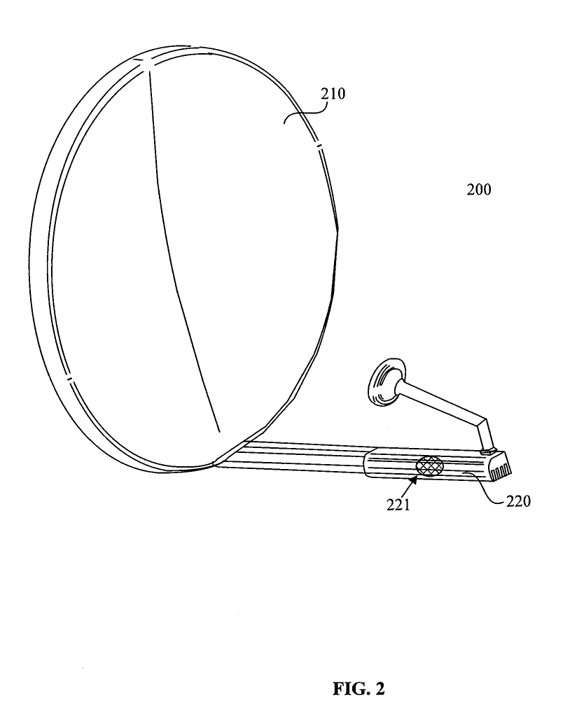

In an exemplary embodiment and with reference to FIG. 2, an antenna system 200 has an outdoor unit (ODU) 220 and an antenna dish 210. In an exemplary embodiment, ODU 200 is an RF electronics unit commonly mounted along with an antenna dish 210 to send/receive satellite signals. Antenna system 200 may be installed at businesses and/or residences for satellite communications. The aiming of antenna system 200 is important in order to receive a stronger satellite signal and improve signal-to-noise ratio (SNR). One example of ODU 220 is Echostar's DISH 1000.2 satellite receiver system.

In accordance with an exemplary embodiment and continued reference to FIG. 2, ODU 220 comprises an audio device 221. In accordance with an exemplary embodiment, audio device 221 is located inside ODU 220. In another embodiment, audio device 221 is separate from, but in communication with, ODU 220. Furthermore, in an exemplary embodiment, audio device 221 is protected from the outside elements by a protective cover.

Audio device 221 may be a piezo-electric buzzer, miniature mylar speaker, or similar audio transducer. In an exemplary embodiment, audio device 221 comprises multiple devices. For example, the audio device may be a CUI CSS-73B16K buzzer. Furthermore, audio device 221 may produce various sounds or vibrations that are audible to an installer of antenna system 200. In an exemplary embodiment, audio device 221 produces a sound with a sound pulse rate and/or frequency useful for aligning antenna system 200. The installer can use the sound to aid in the installation and alignment of antenna system 200 to receive a strong signal. For example, ODU 221 may be configured to increase the speaker sound as the signal strength gets stronger. The installer can then maneuver antenna system 200 until hearing the highest sound, and know that the strongest, or substantially strong, signal is being received. In an exemplary embodiment, signal strength is based on the receive signal strength. In another exemplary embodiment, signal strength is based on SNR data from a modem via a telemetry link. The signal strength may also be indicated to the installer by a series of sounds in which faster sound repetition indicates improved signal strength. Furthermore, signal strength may be indicated by a combination of tone, pitch, repetition, volume, and other patterns.

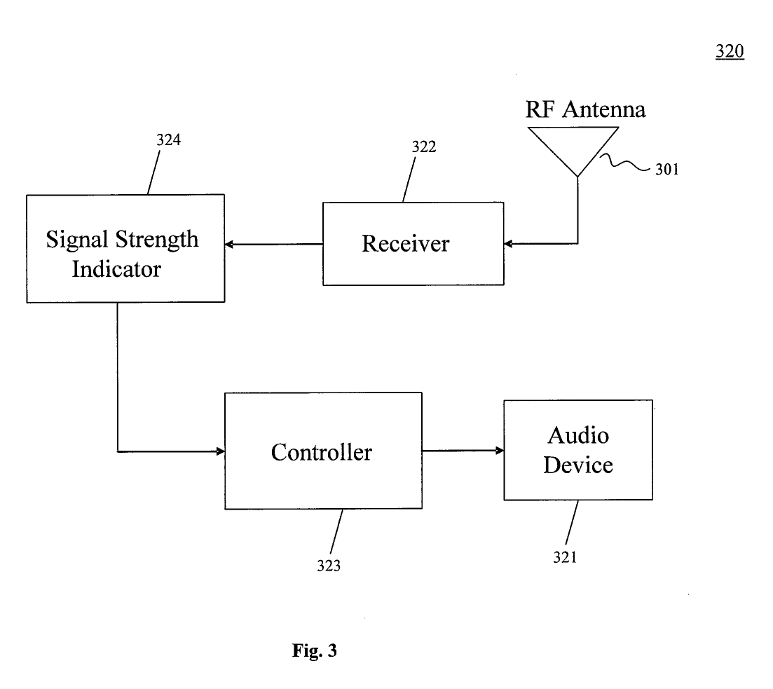

In accordance with an exemplary embodiment and with reference to FIG. 3, an ODU 320 comprises an audio device 321 and a receiver 322. Receiver 322 may be configured to be in communication with an RF antenna 301. In another exemplary embodiment, ODU 320 further comprises a controller 323. In yet another exemplary embodiment, ODU also comprises a signal strength indicator 324. Furthermore, in various exemplary embodiments, controller 323 and/or signal strength indicator 324 are part of an indoor unit, which may be in place of, or in addition to, these components being part of ODU 320.

In an exemplary embodiment, RF antenna 301 receives a signal and communicates the signal to receiver 322. Signal strength indicator 324 reads the signal communicated to receiver 322 and provides input to controller 323 based on the received signal. Furthermore, controller 323 receives input from signal strength indicator 324 and sends a control signal to audio device 321. Audio device 321 generates an audio output based on the control signal. Control signal is configured to control audio device 321 in such a manner as to aid in the aiming of the antenna system.

In an exemplary embodiment, the installer can be any layperson or consumer. The installer does not require any special skills or alignment tools. Furthermore, in an exemplary embodiment, audio device 221 is loud enough for an installer to hear in most conditions, such as traffic, wind, AC units, and the like. In an exemplary embodiment, audio device 221 has an audio level of about 100 dB inside the enclosure, and an audio level of about 70-80 dB outside the enclosure. Moreover, audio device 221 may have any audio level sufficient to aid an installer in the aiming the antenna system.

In another exemplary embodiment, audio device 221 is capable of providing directions to the installer. For example, the directions would be synthesized speech. The speech could provide simple indications as to signal strength (warmer . . . cooler) (higher . . . lower), or it could provide actual directions (up, down, left, right). In an exemplary embodiment, pointing algorithms are included with the ODU in order to achieve installation directions. However, more sophisticated feedback means more processing power and more passing of telemetry data is needed, and the ODU design is adjusted to accommodate these needs.

In addition to an audio device, other indicators may be used. In one exemplary embodiment, the ODU comprises a visual source, which may be in combination with an audio device or stand-alone. The visual source can be a light, multiple lights, gauge, display or the like. For example, in an exemplary embodiment the visual source is a light that changes pulsing rate and/or intensity based on received signal strength. The visual source can be used to indicate signal strength and aid in the alignment of the antenna, much like the speaker described above. A display or gauge could include a signal strength number or histogram-type indicator.

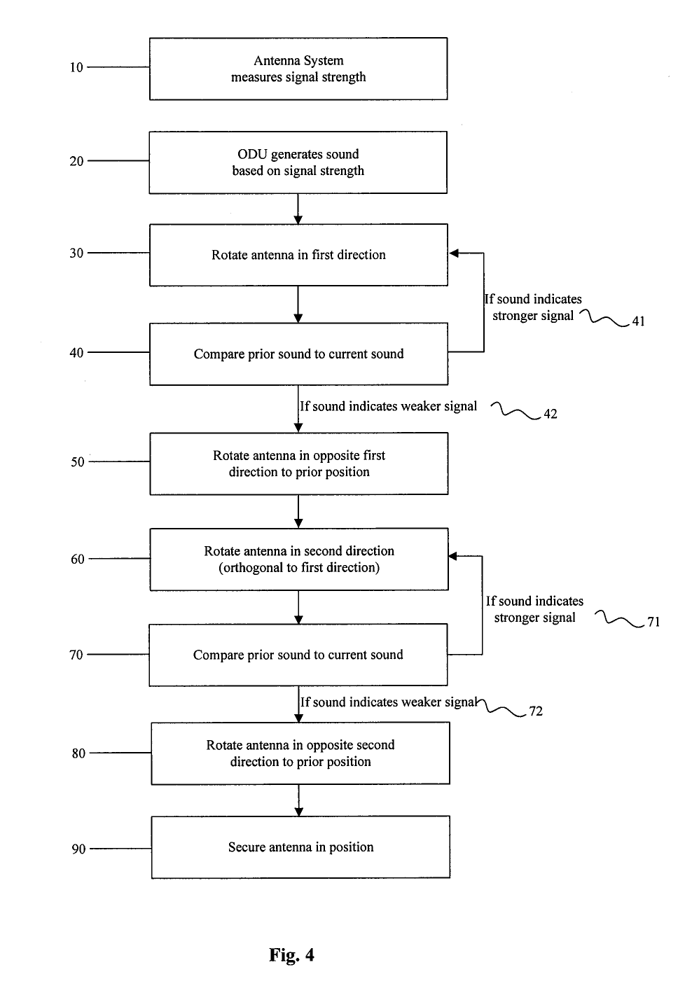

In an exemplary method of installing an antenna system and with reference to FIG. 4, an antenna system measures the signal strength (10) and generates a sound based on the measured signal strength (20). Given the 360° of freedom, the antenna dish is rotated in a first direction (30), ideally in a general direction that is horizontal to the ground. An installer compares the current generated sound with the prior sound (40). If the sound indicates that a stronger signal is being received (41), then the installer continues to rotate the antenna in the first direction (30). If the sound indicates that a weaker signal is being received (42), then the installer rotates the antenna in an opposite direction of the first direction to the prior position (50). In an exemplary embodiment, the prior position is the point where the signal is strongest along the first direction.

After positioning along the first direction is established, the installer rotates the antenna in a second direction (60). In an exemplary embodiment, the plane of the second direction is orthogonal to the plane of the first direction. The installer compares the current generated sound with the prior sound (70). If the sound indicates that a stronger signal is being received (71), then the installer continues to rotate the antenna in the second direction (60). If the sound indicates that a weaker signal is being received (72), then the installer rotates the antenna in an opposite direction of the second direction to the prior position (80). In an exemplary embodiment, the prior position is the point where the signal is strongest along the second direction. Once the positioning for the strongest signal has been determined along the first direction and the second direction, the installer secures the antenna in that position (90).

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as critical, required, or essential features or elements of any or all the claims. As used herein, the terms “includes,” “including,” “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. Further, no element described herein is required for the practice of the invention unless expressly described as “essential” or “critical.”

1. An outdoor unit of an antenna system, the outdoor unit comprising:
an audio device configured to output a sound, wherein the sound varies based on a received signal strength at the antenna system.

2. The outdoor unit of claim 1, wherein the audio device is at least one of a speaker or buzzer.

3. The outdoor unit of claim 2, wherein the speaker is a miniature mylar speaker and the buzzer is a piezo-electric buzzer.

4. The outdoor unit of claim 1, wherein the sound varies by at least one of a sound pulse and a sound frequency.

5. The outdoor unit of claim 1, wherein the sound is synthesized speech that provides alignment instructions to an installer of the antenna system.

6. A method of aiding antenna system alignment, the method comprising:
measuring a signal strength metric;
outputting a sound using an audio device of a transceiver outdoor unit, wherein at least one characteristic of the sound is based on the signal strength metric; and
varying the sound in response to a change in the signal strength metric;
wherein the sound is capable of aiding manual alignment of the antenna system.

7. A method of installing an antenna system, the method comprising:
measuring a signal strength at the antenna system;
generating, at an outdoor unit of the antenna system, a sound based on the measured signal strength;
rotating an antenna dish of the antenna system in a first direction;
comparing a prior sound to a current sound;
continuing to rotate the antenna dish in the first direction in response to the sound indicating a stronger signal;
rotating the antenna dish in a direction opposite the first direction in response to the sound indicating a weaker signal;
rotating the antenna dish in a second direction, wherein a plane of the second direction is substantially orthogonal to a plane of the first direction;
comparing a prior sound to a current sound;
continuing to rotate the antenna dish in the second direction in response to the sound indicating a stronger signal;
rotating the antenna dish in a direction opposite the second direction in response to the sound indicating a weaker signal; and
securing the antenna dish in a position corresponding to a strong signal in both the first direction and the second direction.

8. An antenna system comprising:
an antenna dish;
an outdoor unit configured to receive a radio frequency (RF) signal from the antenna dish; and
an audio device, in connection with the outdoor unit, configured to generate a sound based on the strength of the RF signal received at the outdoor unit.

9. The antenna system of claim 8, wherein the audio device is integrated into the outdoor unit.

10. The antenna system of claim 8, wherein the sound generated by the audio device facilitates aiming of the antenna system.

11. The antenna system of claim 8, wherein at least one of the tone, pitch, volume, repetition, or pulse rate of the generated sound varies in response to the strength of the RF signal.

12. The antenna system of claim 8, further comprising a visual device configured to indicate the strength of the RF signal, wherein the visual device is at least one of a light, a gauge, or a visual display.
